(19) United States
(12) Patent Application Publication
(10) Pub. No.: US 2007/0270199 A1
(43) Pub. Date: Nov. 22, 2007

(54) Watch type mobile phone

(75) Inventors: Joon-Suh Kim, Anyang-si (KR); Ye-Rang Lee, Gunpo-si (KR); Chang-Soo Lee, Bupyeong-gu (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/725,055

(22) Filed: Mar. 16, 2007

(30) Foreign Application Priority Data
May 16, 2006 (KR) P2006-43800

(51) Int. Cl. H04M 1/00

(52) U.S. Cl. 455/575.6

(57) ABSTRACT

A watch type mobile phone is constructed in a manner such that a pair of housings facing each other can rotate relative to each other. The watch type mobile phone includes a body housing, a swing housing facing an upper surface of the body housing and rotatable about a hinge axis which extends in a direction perpendicular to a plane of the body housing, and a swing hinge unit for coupling the swing housing to the body housing so that the swing housing facing the body housing can rotate relative to the body housing.

### PRIORITY

This application claims priority to an application entitled “Watch Type Mobile Phone” filed in the Korean Industrial Property Office on May 16, 2006 and assigned Serial No. 2006-43800, the contents of which are incorporated herein by reference.

### BACKGROUND OF THE INVENTION

1. Field of the Invention

The present invention relates to a watch type mobile phone, and in particular, to a watch type mobile phone constructed in a manner such that a pair of housings facing each other can rotate relative to each other, so that the watch type mobile phone can be miniaturized even though it has a large-size LCD and keypad.

2. Description of the Related Art

Generally, a mobile phone has been developed to provide high sensitivity, miniaturization, and to be lightweight. A bar type mobile phone has been disclosed as a first generation technology, and a flip type mobile phone has been developed as a second generation technology. Currently, the flip type mobile phone and a folder type mobile phone as a third generation coexist and are universalized worldwide.

In addition, a watch type mobile phone which is worn around a body part or the wrist of a user has been disclosed in the art.

As the watch type mobile phone is worn around a body part or the wrist of the user, portability is improved in comparison with other conventional mobile phones, the possibility of loss is decreased, and it is possible to prevent the mobile phone from being dropped during use or from being broken by impact.

Referring to FIG. 1, a conventional watch type mobile phone 1 includes an LCD 2, a speaker 3, a microphone (not shown), an antenna 4, and a battery pack (not shown). The watch type mobile phone 1 further includes a plurality of keys 5 and a band 6.

The band 6 is provided with a keypad 7 which has a 3×4 key arrangement for inputting data to the mobile phone 1.

In the conventional watch type mobile phone 1, since the LCD 2, the microphone, the speaker 3 and the antenna 4 are provided on a single housing, the size of the mobile phone is increased, whereby the miniaturization of the mobile phone 1 is adversely influenced, and the outer appearance of the mobile phone 1 is deteriorated.

Also, due to the fact that the LCD 2, the microphone, the speaker 3 and the antenna 4 are provided on a single housing, the area for placing the LCD 2 and the keypad 7 is decreased. Therefore, as the sizes of the images, characters and symbols displayed on the LCD 2 are decreased, it is inconvenient for a user to watch those images, characters and symbols displayed on the LCD 2.

Also, in the conventional watch type mobile phone 1, because the keypad 7 is provided on the band 6, the mobile phone must be removed from the wrist to be appropriately used, and consequently, it is inconvenient to use the mobile phone 1.

### SUMMARY OF THE INVENTION

Accordingly, the present invention has been made to solve the above-mentioned problems occurring in the prior art, and an object of the present invention is to provide a watch type mobile phone which is constructed in a manner such that a pair of housings facing each other can rotate relative to each other.

Another object of the present invention is to provide a watch type mobile phone which is constructed in a manner such that a pair of housings facing each other can rotate relative to each other, so that a large-size LCD can be provided to one housing and a keypad having a 3×4 key arrangement and opened and closed by the rotation of one housing can be provided to the other housing, whereby, as the component parts are distributed over the respective housings, the watch type mobile phone can be miniaturized and an aesthetic outer appearance can be rendered.

Still another object of the present invention is to provide a watch type mobile phone which is constructed in a manner such that a large-size LCD is provided to one housing and a keypad having a 3×4 key arrangement and opened and closed by the rotation of one housing is provided to the other housing, so that a moving picture can be watched through the large-size LCD and the size of the keypad is increased to enhance convenient use of the mobile phone.

In order to achieve the above objects, according to the present invention, there is provided a watch type mobile phone including a body housing; a swing housing facing an upper surface of the body housing and rotatable about a hinge axis which extends in a direction perpendicular to a plane of the body housing; and swing hinge means for coupling the swing housing to the body housing so that the swing housing facing the body housing can rotate relative to the body housing.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a conventional watch type mobile phone;

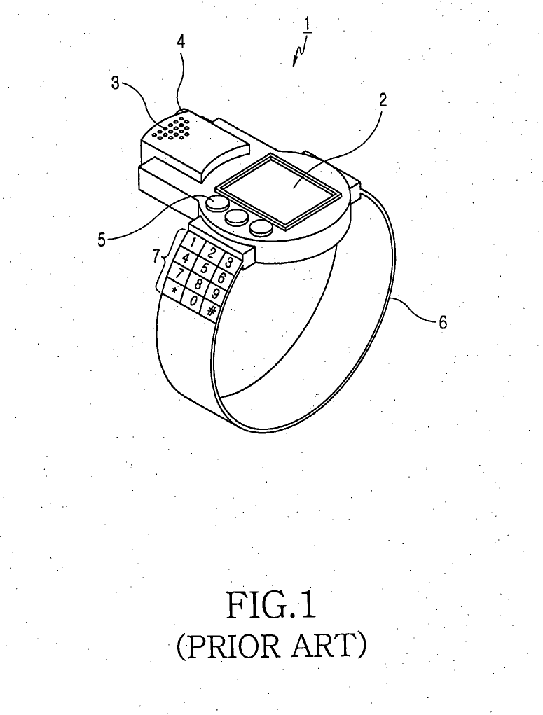

FIG. 2 is an exploded perspective view illustrating a watch type mobile phone in accordance with the present invention;

FIG. 3 is an assembled perspective view illustrating the watch type mobile phone in accordance with the present invention;

FIG. 4 is a perspective view illustrating an opened state of the watch type mobile phone in accordance with the present invention;

FIG. 5 is a cross-sectional view of FIG. 4.

### DETAILED DESCRIPTION OF THE PREFERRED EMBODIMENT

Hereinafter, preferred embodiments of the present invention will be described with reference to the accompanying drawings.

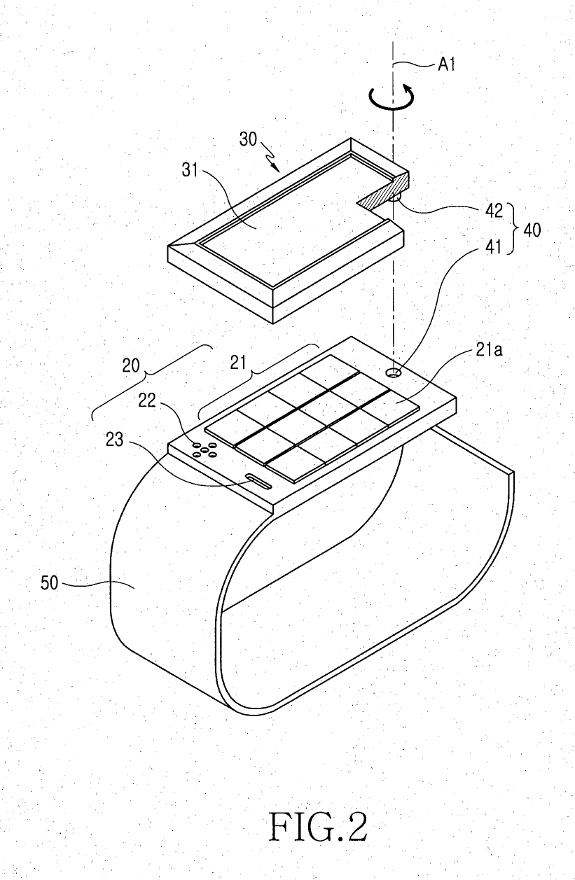

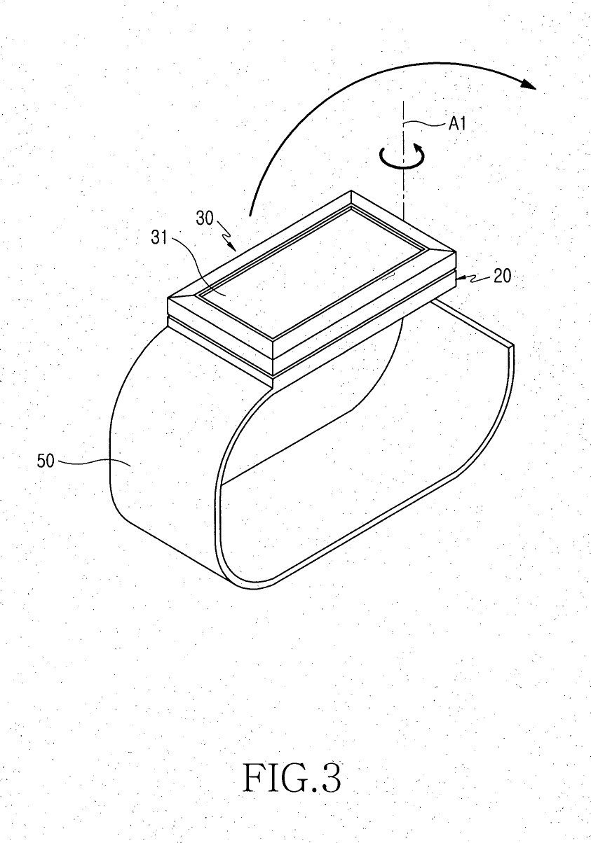

Referring to FIGS. 2 and 3, a watch type mobile phone in accordance with the present invention includes a body housing 20, a swing housing 30, and a swing hinge unit 40. The body housing 20 is connected to one end of a band 50. The swing housing 30 faces the upper surface of the body housing 20 and can rotate about a hinge axis A1 of the hinge unit 40 which extends in a direction perpendicular to a plane of the body housing 20.

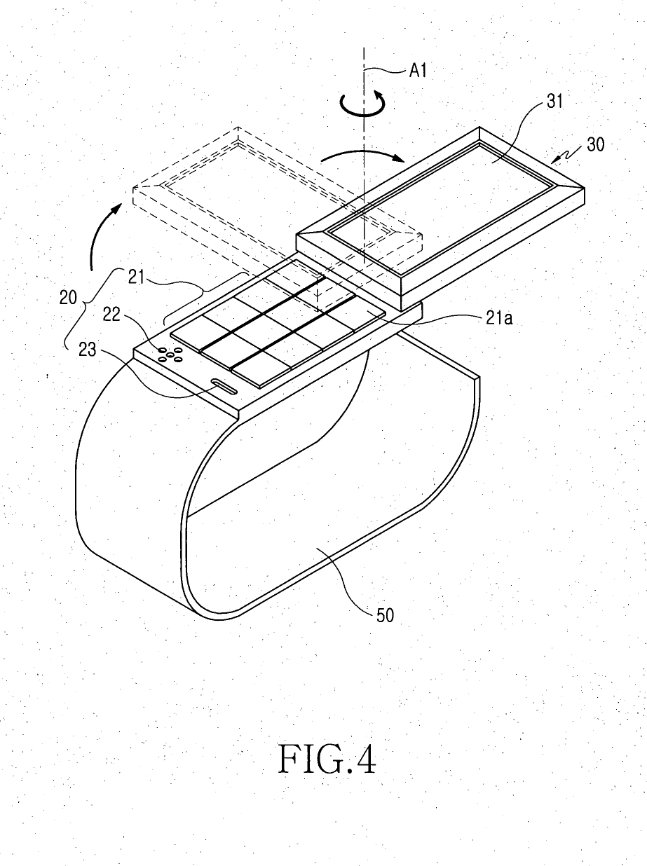

Referring to FIG. 4, the body housing 20 is provided with a keypad 21 which has a 3×4 key arrangement 21a. The body housing 20 is also provided with a microphone 23 and a speaker 22.

Another end of the band 50 is separated from the body housing 20 to define an opening so that the watch type mobile phone can be conveniently worn around the wrist of a user. Band 50 can also be constructed in other ways as desired.

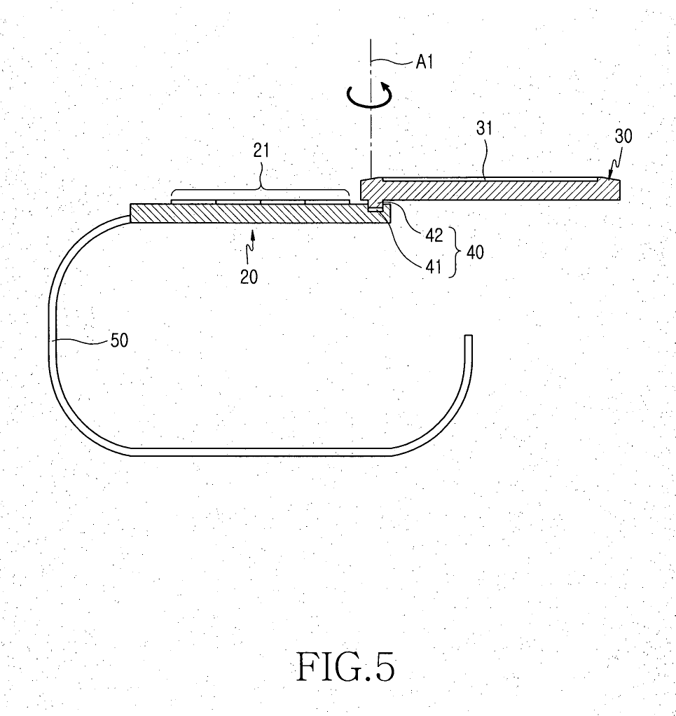

Referring to FIGS. 4 and 5, the swing housing 30 can rotate from the body housing 20, preferably within a range of 180°. The swing housing 30 is provided with a large-size LCD 31.

Referring to FIGS. 2 and 4, the swing hinge unit 40 defines the hinge axis A1 and includes a hinge hole or groove 41 and a hinge post or member 42. The hinge groove 41 is at a lengthwise end of the body housing 20 so that the hinge member 42 rotatably fits therein. The hinge member 42 is on a lower surface of the swing housing 30 at a lengthwise end of the swing housing 30 and rotatably fits into the hinge groove 41.

Hereafter, operations of the watch type mobile phone in accordance with the present invention, constructed as mentioned above, will be described in detail with reference to FIGS. 2 through 5.

As shown in FIGS. 4 and 5, when a user wants to use the watch type mobile phone in the communication mode, the user rotates the swing housing 30 from a closed state to an opened state by 180° about the hinge axis A1 with respect to the body housing 20. In the opened state, the keypad 21, the microphone 23 and the speaker 22 on the body housing 20 are exposed to the outside. Thereupon, the user can implement communication using the communication mode of the mobile phone, and can input various characters and symbols through the keypad 21 having the 3×4 key arrangement.

Since the large-size LCD 31 is provided on the swing housing 30, a TV image, a moving picture, a photograph, etc. can be viewed through the large-size LCD 31.

When the user wants to stop the use of the mobile phone, the swing housing 30 is rotated in a reverse direction about the hinge axis A1 so that the swing housing 30 again faces the upper surface of the body housing 20, as shown in FIG. 3.

The large-size LCD 31 of the swing housing 30 displays a digital watch, a remaining amount of battery power, and so forth.

The watch type mobile phone according to the present invention provides advantages in that, since a pair of housings facing each other can rotate relative to each other, the LCD, the microphone, the speaker and the keypad provided on the mobile phone can be distributed over the respective housings, whereby the watch type mobile phone can be miniaturized and can be conveniently used due to the presence of the large-size LCD and keypad.

While the invention has been shown and described with reference to certain preferred embodiments thereof, it will be understood, by those skilled in the art that various changes in form and details may be made therein without departing from the spirit and scope of the invention as defined by the appended claims.

What is claimed is:

1. A watch type mobile phone comprising:
a body housing;
a swing housing facing an upper surface of the body housing and rotatable about a hinge axis which extends in a direction perpendicular to a plane of the body housing; and
a swing hinge unit for coupling the swing housing to the body housing so that the swing housing facing the body housing is rotatable relative to the body housing.

2. The watch type mobile phone as set forth in claim 1, wherein a keypad having a plurality of keys is provided on the body housing.

3. The watch type mobile phone as set forth in claim 2, wherein the keypad has a 3×4 key arrangement.

4. The watch type mobile phone as set forth in claim 1, wherein a microphone and a speaker are provided on the body housing.

5. The watch type mobile phone as set forth in claim 1, further comprising a band connected to the body housing such that an opening is defined between the body housing and an end of the band.

6. The watch type mobile phone as set forth in claim 1, wherein the swing housing is rotatable from the body housing within a range of 180°.

7. The watch type mobile phone as set forth in claim 1, wherein a large-size LCD is provided on the swing housing.

8. The watch type mobile phone as set forth in claim 1, wherein the swing hinge unit defines the hinge axis, and comprises a hinge groove which is defined in the body housing and a hinge member which is formed on a lower surface of the swing housing and is rotatably fitted into the hinge groove.
